(19) United States
(12) Patent Application Publication
(10) Pub. No.: US 2005/0214160 A1
(43) Pub. Date: Sep. 29, 2005

(54) Supporting device for chromophore elements

(75) Inventors: Claude Weisbuch, Paris (FR); Henri Benisty, Palaiseau (FR); Herve Arditty, Chambourcy (FR)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Genewave

(21) Appl. No.: 11/052,708

(22) Filed: Feb. 1, 2005

Related U.S. Application Data
(63) Continuation of application No. PCT/FR03/02510, filed on Aug. 11, 2003.

(30) Foreign Application Priority Data
Aug. 13, 2002 (FR) 02 10285

(51) Int. Cl. G01N 21/64

(52) U.S. Cl. 422/52

(57) ABSTRACT

A device for supporting chromophore elements comprises a plane mirror covered in a layer of material that is transparent at the wavelengths to be detected, said layer having a set of spots on which the chromophore elements are fixed, the spots being subdivided into a plurality of zones of different thicknesses so as to cause the intensity of the fluorescence emitted by the chromophore elements to vary by destructive interference or by constructive interference, respectively.

### CROSS-REFERENCE TO RELATED APPLICATIONS

This application is a continuation of PCT/FR03/02510, filed Aug. 11, 2003, claiming priority from French Application No. 02 10285, filed Aug. 13, 2002 which is hereby incorporated herein in its entirety by reference.

### BACKGROUND OF THE INVENTION

The invention relates to a device for supporting chromophore elements.

In devices of this type, commonly referred to as “biochips” chromophore elements are chemical biological molecules that are generally fixed on a substrate after a hybridization or affinity reaction in a liquid, or else they are dye elements added or grafted to such molecules or certain types of semiconductive nanostructure such as quantum boxes or wires, each chromophore element being suitable for emitting light spontaneously (i.e. by bio- or chemi-luminescence) or else in response to light excitation (i.e. fluorescence) at a determined wavelength which depends on the nature of the chromophore element.

Devices for supporting chromophore elements are described in particular in patent application WO-A-02/16912 in the names of Claude Weisbuch and Henri Benisty and include means for reinforcing the excitation light intensity of the chromophore elements and for increasing the light intensity emitted by said elements, by using interference effects produced by stacks of layers of suitably-chosen materials and by means of extraction effects applied to light guided by lateral structures having dimensions of the same order of magnitude as the wavelengths of the guided light, such as photonic crystals, in particular.

In such biochips, the chromophore elements are fixed on substrate areas known as “spots” that are separated from one another and arranged regularly, in particular in rows and in columns. By way of example, the size of such spots is about a few tens or hundreds of micrometers (μm), which is considerably greater than the wavelengths under consideration.

The spots where the chromophore elements are fixed, e.g. during a hybridization step, are defined e.g. by a deposition technique of the so-called “spotting” type which comprises physicochemical treatment of the surface of the overall substrate, with each spot then being determined by the area that is wetted by the fluid deposit, or by three-dimensional selective treatment, e.g. by selective silanization, with each spot being determined by such treatment. Spots may include chromophore elements of different types, generally two different types, e.g. Cy3 and Cy5 that emit at different wavelengths. The emitted signals are picked up by suitable photodetectors, in particular strips or arrays of photodetectors of the charge-coupled device (CCD) type which also picked up overall background noise that can be formed by incompletely filtered excitation light, by fluorescence coming from chromophore elements on adjacent spots in the form of grazing or guided light rays, etc., where such background noise is difficult to eliminate completely for each wavelength under consideration and can represent a significant fraction of the intensity of the signal that is picked up.

Depending on the type of apparatus used, the information carried by the light emitted by the chromophores can be read from one face or from the other face of the support.

Measurement can be performed on dry biological material or on material in a liquid phase, for which the chromophore elements carrying the information are those which are specifically attached to the spots of the support, the liquid including in its volume a certain quantity of chromophores in suspension that do not provide information and that form a source of background noise at the emission wavelengths of the chromophores, and also particles that diffuse light, likewise constituting sources of background noise.

### SUMMARY OF THE INVENTION

A particular object of the present invention is to provide a simple and effective solution to the problem of determining and eliminating such background noise.

Another object of the invention is to optimize the structure of the substrate to enable it to be used at a plurality of different wavelengths corresponding to different types of chromophore.

A particular object of the invention is to provide a device for supporting chromophore elements that enables the above-mentioned background noise to be determined in a manner that is reliable, accurate, and automatic.

To this end, the invention provides a device for supporting chromophore elements suitable for emitting light by bioluminescence or chemiluminescence or by fluorescence in response to light excitation, the wavelength emitted by each chromophore element depending on the nature of the element, said chromophore elements being fixed on spaced-apart spots of the surface of the support, wherein the surface of the support is structured as a plurality of zones presenting optical properties differing in transmission and in reflectivity phase and amplitude, said properties resulting from the presence or absence in said zones of at least one set of layers selected from the following:
at least one layer forming a totally or partially reflecting mirror;
at least one layer that absorbs, at least in part, at least one of the emission and/or excitation wavelengths; and
at least one layer that is transparent at all of the emission and excitation wavelengths;
said layers being designed to produce at least one of the following effects:
destructive or constructive interference at at least one emission wavelength in order to generate different values of light intensity emitted by the chromophore elements;
destructive or constructive interference at at least one excitation wavelength for generating different values of the intensity of the fluorescence emitted by the chromophore elements; and
absorption on excitation and/or emission to generate different values of light intensity transmitted by the substrate.

The device of the invention thus includes a variety of optical environments serving to mix the useful signal with the background noise in different ways, thus making it possible with suitable digital processing to reconstitute the useful signal. For example, for a given wavelength, a first type of zone may produce the following measurements:
Measurement(1)=a1*Signal+b1*Noise (A)
whereas a second type of zone will produce the following measurement:
Measurement(2)=a2*Signal+b2*Noise (B)
where the coefficients a1 and b1 are the transfer parameters of the zone 1 at the wavelength under consideration, while a2 and b2 are those of the zone 2. These parameters are known by construction or else by calibration. It then suffices to solve the system of two equations (A, B) in two unknowns in order to deduce the looked-for values “Signal” and “Noise”.

The values of the coefficients a1 and a2 can be caused to vary, for example by using amplifying layers for the emitted light and/or the excitation light, as described in patent application WO-A-02/16912 in the names of Claude Weisbuch and Henri Benisty, on the basis of destructive or constructive interference effects.

Reconstruction of the signal is simplified, in particular:
for a structure in which a1 is zero; under such circumstances, solving the system of two equations (A, B) in two unknowns becomes particularly simple; and
when b1=b2=1; in which case noise can be eliminated by subtracting (B) from (A).

Depending on the application, the dimensions of these zones can be greater than, smaller than, or equal to the dimensions of the above-mentioned spots.

When a zone is smaller than a spot, solving the Signal-Noise system takes place locally on a single spot having the different zones. Otherwise, the Signal-Noise system is solved by comparing measurements taken from different spots situated in different zones.

When measurement is performed through the support, it is possible to add a parameter which is absorption at the various wavelengths.

In general, the background noise corresponding to the liquid phase may have intensity of the same order of magnitude as that of the useful signal, or even greater. That is one of the reasons why measurements are not usually performed in the presence of the liquid phase. The invention makes it possible to solve this problem effectively, which represents more than merely improving performance, and corresponds to a novel type of measurement and apparatus. This solution also makes it possible to provide time resolution in the measurement since the process of chromophore element bonding or hybridization can thus be analyzed while it is taking place.

The support can be structured using the conventional lithographic techniques of lift-off and/or dry or wet etching. Those techniques make it possible in particular to create orifices in one or more layers. Thereafter, it is possible to deposit in those orifices one or more layers of materials that are different from those of the layers in which the orifices were made.

A particular embodiment corresponds to relatively simple structuring (no absorption layer) obtained by modulating the thickness of a transparent layer situated over a reflecting layer. In addition, reconstruction of the signal can be simplified by making a structure or a zone type in which the useful signal is canceled out (a1=0).

In such an embodiment, the device comprises a plane mirror covered in a layer of material that is transparent at the emitted wavelengths and on which the chromophore elements are distributed in mutually separate spots of lateral dimensions that are greater than the wavelengths of the emitted fluorescence, and said layer of transparent material is of a thickness of the same order of magnitude as the wavelengths of the emitted fluorescence and comprises, for each chromophore element spot, at least two zones of different thicknesses, the thickness of a first zone being determined to generate an intensity minimum in the fluorescence emitted at one particular wavelength by the chromophore elements in said zone by means of a phenomenon of destructive interference.

In such a device, if the thickness of the first zone is properly adjusted, then the fluorescence emitted from the surface of said zone has a minimum value which is zero or substantially zero. Consequently, light signals picked up from the surface of this zone represent the overall noise at the wavelength in question.

The fluorescence from the zone in question is canceled out either:
by a go-and-return light path through the mirror that is equal to an odd multiple of the half-wavelength of the emitted fluorescence, given the phase shift that occurs on reflection at the mirror and/or penetration of the wave into the mirror;
by a go-and-return light path to the mirror which is equal to an odd multiple of the excitation half-wavelength, taking account of the phase shift on reflection at the mirror and/or penetration of the wave into the mirror;
by a combination of the two above-mentioned effects; or
when the two above conditions are close together and correspond to thicknesses that differ typically by less than 30 nanometers (nm), by some arbitrary condition intermediate between the two above conditions.

The two effects can thus coincide if the angle of incidence of the excitation light is selected for this purpose.

According to another characteristic of the invention, the layer of transparent material includes at least one other zone of thickness different from that of the first zone, such that the path length differences in the two zones at a given wavelength is approximately equal to an odd multiple of one-fourth of said wavelength. This zone maximizes amplification of the emitted fluorescence.

As mentioned above, the wavelength under consideration for determining the difference in thickness between the two zones may be either the wavelength of the emitted fluorescence, or the excitation wavelength, or both the wavelength of the emitted fluorescence and the excitation wavelength (in order to obtain in said other zone an excitation intensity maximum and an emitted fluorescence intensity maximum), or indeed some intermediate condition when the thicknesses of the two zones are determined for two wavelengths that are very close to each other.

The fluorescence emitted by said other zone then has intensity that is at a maximum or close to a maximum value, so the light signal picked up at the surface of said other zone corresponds to the sum of the maximum intensity of the fluorescence emitted at the first wavelength over the area of said other zone, plus the overall background noise. By subtracting from this signal the background noise as obtained by picking up the signal from the surface of the first zone, an intensity value is obtained that corresponds approximately to the maximum intensity of the fluorescence emitted from the surface of said other zone at the first wavelength.

According to other characteristics of this embodiment seeking to generalize the above-mentioned characteristics:
for each chromophore element spot, the layer of transparent material comprises a plurality of the above-mentioned zones of different thicknesses, making it possible to sample the intensity of the fluorescence emitted at said first wavelength by the chromophore elements of said spot at values between a minimum value and maximum value; and
for each chromophore element spot, the layer of transparent material comprises a plurality of the above-specified zones of different thicknesses, thus making it possible to vary the intensity of the fluorescence emitted at different wavelengths by chromophore elements of different types in said spot.

Thus, with a series of zones of known different thicknesses in each chromophore element spot, it is possible to obtain a linear combination of the meaningful signals emitted by the various chromophore elements that are present and of the background noise.

According to other characteristics of the invention, said zones are arranged in rows or strips parallel to the surface of said layer of transparent material.

In a variant, the zones may be in a matrix disposition of rows and columns at the surface of the layer of transparent material.

In which case, the layer of transparent material comprises over its entire area a plurality of zones of different thicknesses that are preferably regularly distributed and that form a structure of tiled or analogous type.

In a variant, the zones of different heights may be formed on the above-mentioned reflecting layer or on an intermediate layer of different refractive index that is interposed between the transparent layer and the reflecting layer.

The means for sensing the fluorescence emitted by the chromophore elements may be located above the device for supporting the chromophore elements, or beneath it, as already described in the above-specified international patent application WO-A-02/16912.

In which case, said sensor means may comprise a matrix of photodetectors of the CCD type or of the complementary metal oxide on silicon (CMOS) type fixed beneath the device, said matrix comprising a first layer of material that is highly reflective at the excitation wavelength and a second layer of material that selectively absorbs the excitation radiation, the first layer being placed on the second, so that the emitted fluorescence, but not the excitation radiation, reaches the detectors easily. Reflection of the excitation radiation on the first layer may then optionally serve to provide the above-mentioned effects of reinforcing the emitted fluorescence.

A weakly resonant cavity is formed between the interface surface on top of the layer carrying the chromophore elements and said first reflecting layer (at the excitation wavelength) when said layer also presents non-negligible reflectivity at the wavelength of the emitted fluorescence. Advantage can be taken of this effect to increase the intensity of the fluorescence channeled to the photodetectors.

Preferably, the top layer of the device is made of a material having a high refractive index. This enhances formation of said weakly resonant cavity and thus enhances good detection of the fluorescence by the photodetectors disposed under the device.

It is also known that the emission of radiation into the medium on which a chromophore element is placed is enhanced with increasing refractive index of the medium.

Furthermore, by causing the level of absorption of the excitation light to vary between the various zones (by varying the thickness and/or the absorption coefficient of the absorbent layer) it is also possible to improve the accuracy of measurement performed by solving the above-mentioned system of equations (A) and (B).

For example, it is possible to provide a chromophore element support operating in transmission with an absorbent layer that is structured in such a manner as to have two types of zone with dimensions smaller than those of the chromophore elements spots, and such that transmission of the excitation light is twice as great in a first type of zone than in the second type of zone. Simultaneously, the device may be designed to have the same level of useful signal in both types of zone. Furthermore, it is assumed herein that the background noise at the emission wavelength is negligible. Under such circumstances, the above-mentioned system of equations (A) and (B) is written as follows:
Measurement(1)=a*Signal+2*Noise(excitation)
Measurement(2)=a*Signal+Noise(excitation)

The useful signal separated from the noise due to the excitation light can easily be determined by subtracting the measurement performed on the first type of zone from twice the measurement performed on the second type of zone:
A*Signal=2*Measurement(2)−Measurement(1)

When working simultaneously at two different wavelengths, and if there are only two different types of zone (which is the simplest configuration for producing industrially), it is possible to select two simple types of architecture, each presenting its own advantages.

One zone maximizes emission of a first type of chromophore and the other zone minimizes said emission. Under such circumstances, the first type of chromophore is processed in targeted manner, while the second type of chromophore is processed generically; or one zone maximizes emission of a first chromophore and the other zone maximizes emission of a second type of chromophore. Under such circumstances, both types of chromophore are treated in a manner that is targeted for the signal, with noise being treated generically.

The invention also applies to chemiluminescent compounds. Under such circumstances, the structuring of the structure of the support takes account only of emission wavelengths.

The invention also applies to micro-plate format (“SBS” format) (e.g. having 24, 96, 384, or 1536 wells), with the structuring of the surface of the support then being adapted to the geometry of the wells in the micro-plates so as to present one or more zones per well.

In an embodiment, the structured support constitutes the common bottom for all of the wells of a micro-plate. In another embodiment, individual supports are placed at the bottom of each well in a monolithic micro-plate.

The invention also applies to micro-plates in the microscope slide format with micro-wells made by depositing a layer having a thickness of several tens of micrometers with orifices forming the wells (e.g. Teflon-type HTC treatment sold under the Cel-Line trademark by Erie Scientific Corp., Portsmouth, N.H.). The various wells can be used as separate hybridization zones for different test samples.

In such applications, the bottom of each well may have one or more spots with chromophore elements fixed thereto.

### BRIEF DESCRIPTION OF THE DRAWINGS

The invention will be better understood and other characteristics, details, and advantages thereof will appear more clearly on reading the following description given by way of example with reference to the accompanying drawings, in which:

FIG. 1 is a diagrammatic plan view of a portion of a device of the invention;

FIG. 2 is a fragmentary view on a larger scale than FIG. 1;

FIGS. 3A, 3B, and 3C are views corresponding to FIG. 2, in various embodiments of the invention;

FIG. 4 is a fragmentary diagrammatic perspective view showing another variant embodiment;

FIGS. 5A and 5B are diagrammatic fragmentary views in section of two embodiments of a device of the invention;

FIG. 6 is a view on a larger scale showing a portion of the section shown in FIG. 5A;

FIG. 7 is a graph showing diagrammatically the intensity of fluorescence as emitted from the surface of three different zones of the FIG. 6 device; and

FIGS. 8 to 13 are diagrammatic section views of other variant embodiments of the device of the invention.

### MORE DETAILED DESCRIPTION

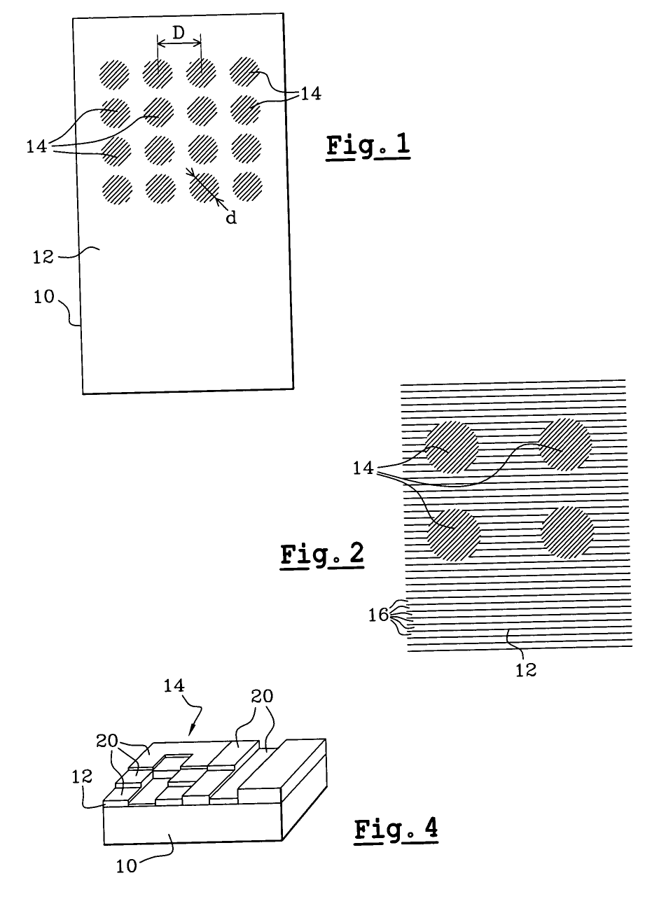

The device shown diagrammatically in FIG. 1 comprises a support 10 of generally rectangular shape, whose top face 12 has a plurality of spots 14 on which chromophore elements are fixed, these spots 14 forming a set in which they are distributed in regular manner in rows and columns, for example.

Typically, the spots 14 are of dimension (diameter d) of the order of 30 μm to 400 μm, with the distance between centers D between adjacent spots being of the order of 40 μm to 500 μm. As mentioned above, the dimensions of the spots are determined by depositing a fluid or by selective three-dimensional treatment.

The support can be made of glass, silicon, silicon carbide, sapphire (Al₂O₃), metal, or a plastics material.

The top portion of the support 10 carries a layer 12 of material that is transparent to the wavelengths of the fluorescence emitted by the chromophore elements of the spots 14 in response to light excitation, the layer 12 comprising at least a dielectric material such as, for example: a semiconductive material, an oxide, a glass, a nitride, a fluoride, a chalcogenide, an organic polymer, or an inorganic or organometallic compound obtained by a sol-gel process. The refractive index of the material is preferably relatively high, and it is constituted, for example, by TiO₂ which has a refractive index lying in the range 2.2 to 2.5 depending on the crystal form used. In a variant, the layer 12 is made of SiO₂ in order to optimize the quality of the chemical functionalization of the surface of the support.

The transparent layer 12 may also be made out of an organic polymer having a surface that is plane or rough (3D effect). The 3D effect increases the effective surface area of the device. The transparent layer 12 may also be porous.

The thickness of the layer 12 is of the same order of magnitude as the wavelengths of the fluorescence emitted by the chromophore elements and it covers a plane mirror that may be reflective at the excitation wavelength, said plane mirror being above all reflective at the wavelengths of the emitted fluorescence.

The free surface or top surface of the layer 12 is structured, e.g. in the manner shown diagrammatically in FIGS. 2, 3, and 4.

In FIG. 2, the layer 12 comprises a plurality of parallel strips 16 of different thicknesses, these strips being of width in the plane of the layer 12 which is greater than the wavelengths of the fluorescence emitted by the chromophore elements and less than the dimensions in said plane of the spots 14. The thicknesses of the various strips 16 are determined so that, in each spot 14, one of these thicknesses produces a destructive interference effect at the surface of the layer 12 for an excitation wavelength and/or for a given wavelength of the fluorescence emitted by the chromophore elements. The other strips 16 are of different thicknesses, one of which corresponds to a constructive interference effect at the top surface of the layer 12 for the excitation wavelength and/or for the wavelength of the emitted fluorescence. The strips 16 of different thickness are formed in alternation in the layer 12, their thicknesses being determined so as produce the above-destructive interference and constructive interference effects for one or preferably a plurality of wavelengths emitted by the various chromophore elements present in the spots 14 and/or for the corresponding excitation wavelengths.

Thus, considering a given wavelength emitted by the chromophore elements of a spot 14, it is possible to determine two thicknesses corresponding to the two above-mentioned interference effects and also one or more intermediate thicknesses, thus making it possible to sample the light intensity emitted at said wavelength between a minimum value and a maximum value.

It is also possible to determine other thickness for the strips 16 which correspond to destructive and constructive interference effects for one or more other wavelengths emitted by the chromophore elements and/or for the corresponding excitation wavelengths.

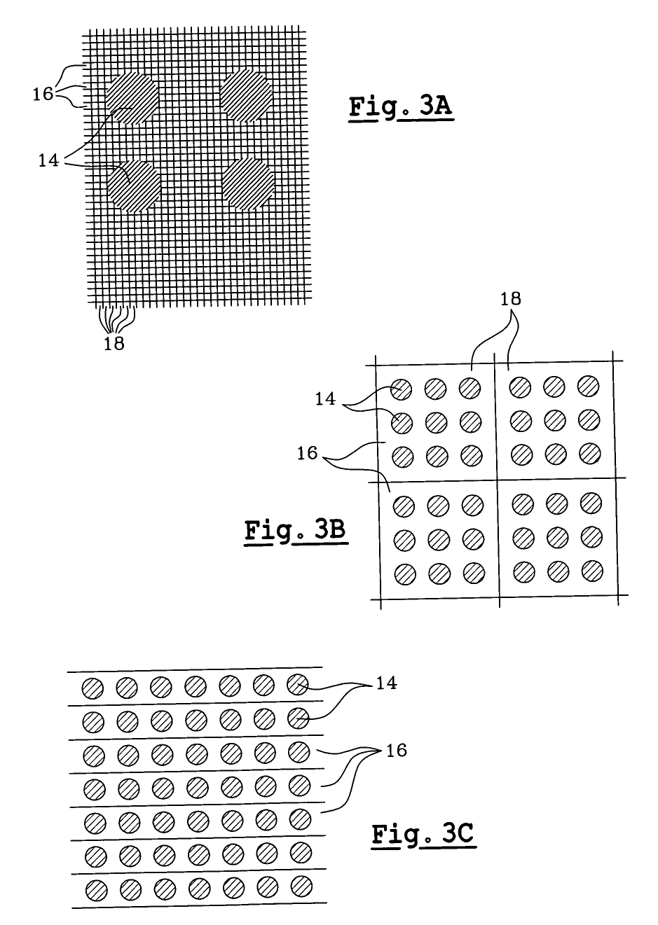

As shown diagrammatically in FIG. 3A, it is also possible to form strips 16 and 18 in the layer 12 that are of different thicknesses and that extend in two perpendicular directions. The mutually-parallel strips 16 of different thicknesses are transverse strips and they are intersected at right angles by longitudinal strips 18 which are mutually parallel and of different thicknesses.

In each spot 14, this produces a structure of the kind shown diagrammatically in perspective in FIG. 4 in which each spot 14 has a plurality of adjacent square or rectangular levels 20 at different heights. The dimensions of these levels 20 in the top surface of the layer 12 may be identical from one level to another or they may differ.

As shown diagrammatically in FIGS. 3B and 3C, the support may also be structured with zones 16 of dimensions that are greater than the dimensions of the chromophore element spots 14.

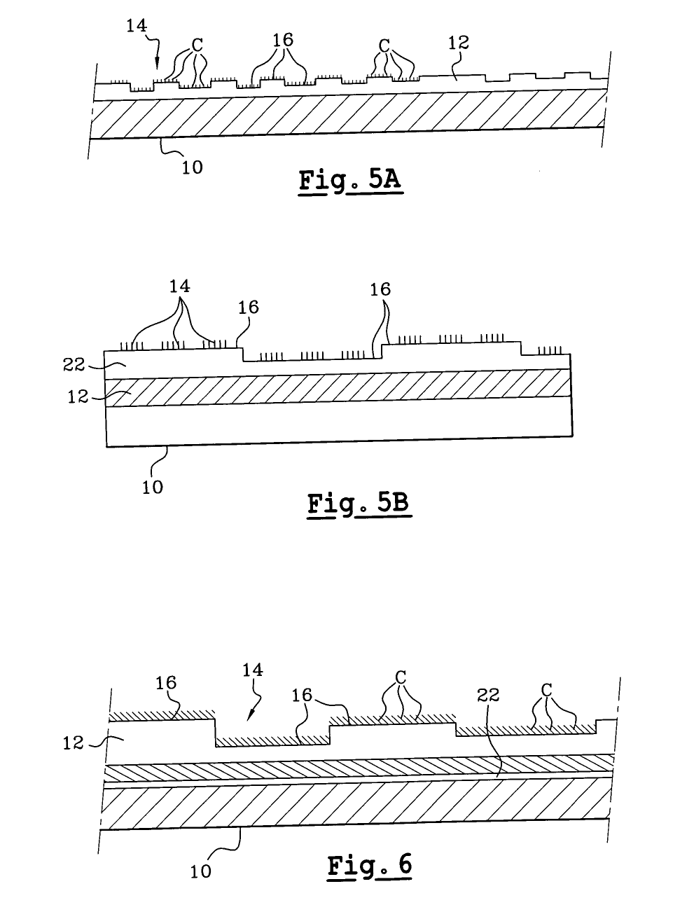

As can be seen in FIGS. 5 and 6, the layer 12 of transparent material carrying the chromophore elements C is formed on a plane mirror 22 which is highly reflective, at least for the fluorescence emitted by the chromophore elements. The plane mirror is formed by one or more layers of a reflective metal or of a dielectric material, such as, for example: a semiconductive material, an oxide, a glass, a nitride, a fluoride, a chalcogenide, an organic polymer, or a compound obtained by the sol-gel process from inorganic or organometallic compounds. In a particular embodiment, the plane mirror 22 is made of silicon.

In a variant embodiment, the plane mirror 22 comprises at least one metal layer deposited on the support, e.g. a layer of aluminum, gold, silver, or chromium. Metal mirrors are generally completely opaque in the visible region of the light spectrum.

In yet another variant embodiment, the plane mirror comprises at least two layers of oxides such as, for example, SiO₂ and TiO₂. TiO₂ may be replaced by Nb₂O₅, Ta₂O₅, or Hf₂O₅.

In another variant, the plane mirror 22 comprises at least one layer of SiO₂ and at least one layer of amorphous silicon.

In practice, the thicknesses of the strips 16 leading to constructive and destructive interference respectively need to be determined while taking account of the penetration depth into the mirror 22 (and thus the phase change on reflection) of the excitation or of the fluorescence at the wavelength under consideration, and also of the reflectivity of the mirror and the refractive index of the transparent layer 12.

By way of example, the mirror 22 may be a dielectric mirror (a Bragg mirror) as is well known to the person skilled in the art, being characterized by reflectivity greater than 70% and by a Bragg wavelength (on which the Bragg mirror is centered). The Bragg mirror can thus be centered on the excitation wavelength or on the emission wavelength of one type of chromophore element or else on a wavelength that is intermediate between said wavelengths. For example, when using a Cy5 chromophore having an emission maximum at 670 nm and excited by a helium neon (He—Ne) laser at 633 nm, the Bragg mirror may be centered around 655 nm. When using a plurality of different types of chromophore elements, the mirror may be centered on a wavelength intermediate between the emission and/or excitation wavelengths of the various types of chromophore. For example, when using both Cy3 chromophores (excitation at 542 nm and emission around 570 nm) and Cy5 chromophores (excitation at 633 nm and emission around 670 nm), the center wavelength of the mirror can be selected at 605 nm.

In a preferred embodiment for making a Bragg mirror, use is made of a stack of dielectric layers of SiO₂ and TiO₂, or of SiO₂ and Nb₂O₅, providing particularly high refractive index differences.

In another variant embodiment that is particularly advantageous, the reflective layer 22 is an optical microcavity comprising two (dielectric or metallic) mirrors that are spaced apart by a transparent layer (“the cavity”) having an optical thickness of 2*n*λ_{c}/4 where n is an integer and the wavelength λ_{c} is selected in the spectrum range where the reflectivity of the two mirrors is high. The device may be structured, for example, by modulating the thickness between different zones of the transparent layer covering the stack, or by modulating the thickness of the cavity layer.

In a variant, the reflective layer 22 is a multiple optical microcavity structure, e.g. comprising three mirrors and two cavities.

Bragg mirrors or microcavity structures are generally stacks that are semitransparent in the visible range of the spectrum.

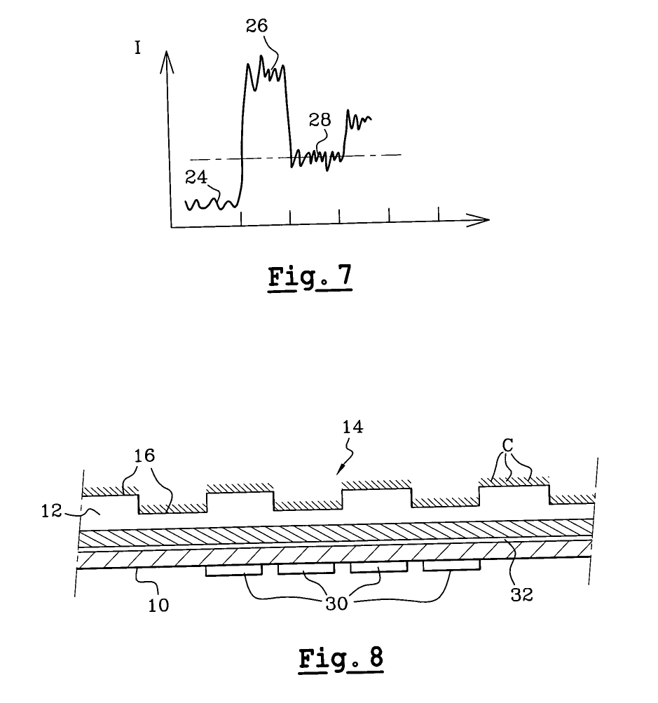

FIG. 7 is a diagram showing the signals that can be sensed from above zones of different thicknesses in a spot 14, with intensity I being plotted up the ordinate and a dimension in the plane of the layer 12 being plotted along the abscissa.

The curve shown in FIG. 7 has a first portion 24 of minimum intensity corresponding to a destructive interference effect, a portion 26 of maximum intensity corresponding to a constructive interference effect, and a portion 28 of medium intensity corresponding, for example, to the signal that would be obtained in the absence of a plane mirror 22, i.e. in the absence of any interference phenomenon. It is thus clear to the person skilled in the art that for each wavelength under consideration of fluorescence emitted by the chromophore elements, it is possible to take account of the minimum and maximum sensed intensity values 24 and 26, and take the difference between them in order to eliminate overall background noise, which includes both local noise and remote noise that does not come from the zone under consideration.

Knowing the structure of the top layer 12, i.e. the locations of the strips 16 that correspond to destructive interference effects at one or more wavelengths, and the locations of the strips 16 that correspond to a constructive interference effect for said wavelength(s), it is possible to take account directly of the minimum intensity signals and the maximum intensity signals, thereby greatly simplifying analysis. If a matrix of CCD photodetectors is used for sensing the emitted fluorescence, it is not even necessary to know which matrix photodetector is associated with such-and-such a zone of the spot 14, since, given knowledge of the structure of the surface of the layer 12, analyzing the image itself makes it possible to find and identify the zones of minimum and maximum intensity.

A variant of the invention consists in structuring the mirror 22 into zones by omitting the reflective layer in certain zones, i.e. by creating orifices in said layer. Under such circumstances, pairs of signals 26 and 28 or 24 and 28 used as modulation of the signal to be detected, depending on the thickness selected for the layer 12 having a plane top face.

FIG. 8 shows a variant embodiment of the invention in which a set of CCD-type photodetectors 30 or the like is located under the support 10, on its face opposite from the face carrying the chromophore elements C. This embodiment presents the advantage of not requiring a lens to form an image on the photodetectors 30. In addition, the various layers (transparent, reflective, and/or absorbent) of the support can be deposited on a matrix of CCD elements.

In this embodiment, the emission of fluorescence downwards towards the photodetectors 30 is modulated by the same interference effects as those described above, but the amplitude of these effects is determined by a physical mechanism that is different and that is generally weaker: this phenomenon is multiple wave interference associated with the fact that the layer 12 forms a weakly resonant cavity, having one of its mirrors constituted by the interface with air or the medium in which the top surface of the layer 12 is immersed, and with its other mirror being formed by a layer 32 which is semi-reflective at the wavelength of the fluorescence that is to be detected, and which is highly reflective for the wavelength used for exciting the chromophore elements. The strength of the resonance of such a cavity and the amplitude of the modulation of the fluorescence signals as collected increases with increasing value for the product of the amplitude reflectivities of the two mirrors. It is thus advantageous to use a top layer 12 having a high index, e.g. being made of TiO₂ with a refractive index lying in the range 2.2 to 2.5 depending on its crystal form. The amplitude reflectivity of the TiO₂/air interface is about 0.4. In addition, it is known that the emission of radiation towards the medium on which the chromophore elements are located is enhanced with increasing refractive index of said medium. These two effects combine and therefore enhance detection of the signals by the photodetectors 30.

In the example shown, a photodetector 30 is located under each zone or strip 16 of different height in a slot 14. It is thus known directly which photodetector 30 faces any particular zone or strip 16 corresponding to an emission maximum or minimum. Naturally, a plurality of photodetectors 30 could be provided under each zone or strip 16 of different height.

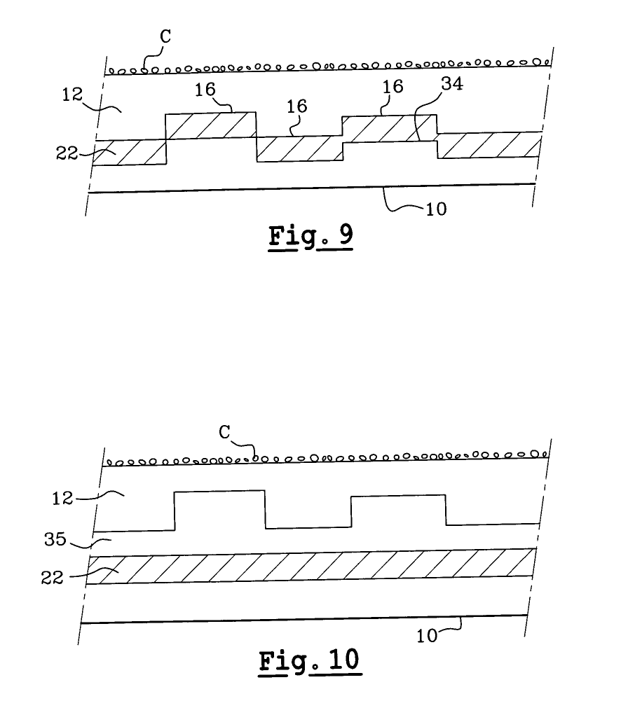

In the embodiment of FIG. 9, the top layer 12 of transparent material has a top surface that is plane and the mirror 22 is formed on a structured top face 34 of the support 10. It is this surface 34 that carries the above-described zones 16, 18, and 20 of the layer 12 in the above-described embodiments.

When, as shown in the drawings, the thickness of the reflective layer 22 is constant in each zone, then the sudden discontinuities between the zones can form parasitic channels for the excitation wavelengths and possibly also for the emitted fluorescence. In a smoother variant (e.g. of triangular or undulating section), the thickness of the substrate enables this drawback to be mitigated. Under such circumstances, the zones are defined by the fact that the desired interference conditions are substantially achieved therein.

In another variant shown in FIG. 10, the substrate 10 of the device comprises a plane mirror 22 and a plane top layer 12, with an intermediate layer 35 of different index, which intermediate layer is structured with zones of different thicknesses, corresponding to the above-mentioned zones 16 and giving rise to the variations in the intensity of the fluorescence by phase shifting.

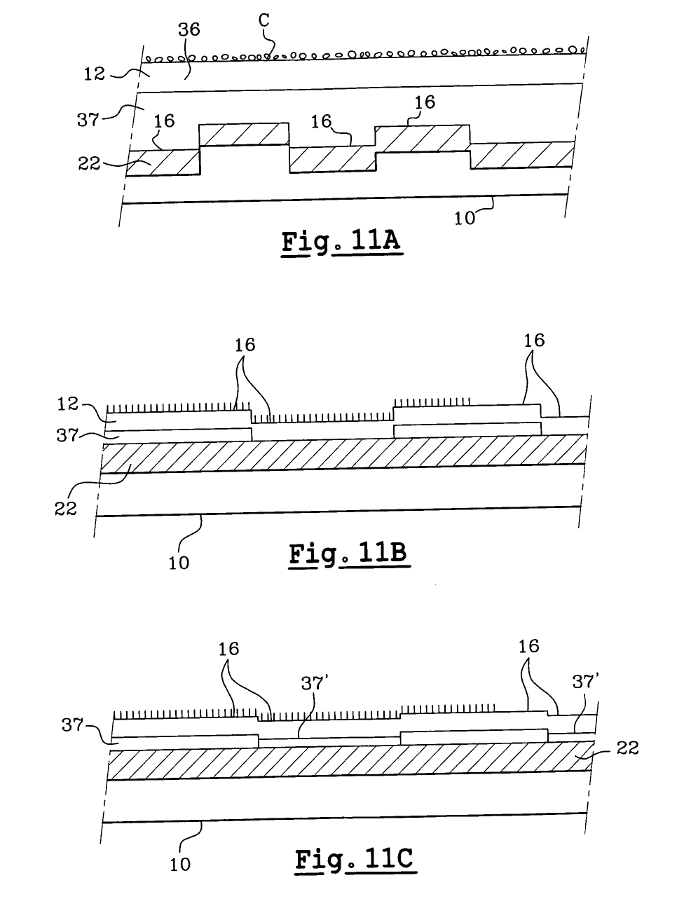

In another variant, shown in FIG. 11A, the device has one or more top layers deposited on a transparent intermediate layer 37 so as to form a waveguide 36 for the excitation radiation, e.g. with propagation along the above-mentioned strips formed by the mirror 22 so as to avoid causing excitation radiation from escaping via the discontinuities between the strips and being diffused in undesirable manner towards the photodetectors. In order to avoid this drawback, it is also possible to ensure that the layer of material covering the structured mirror 22 is of sufficient thickness to enable the profile of the guided mode with its evanescent portion to be spaced far enough away from the structured surface of the mirror 22.

Another variant of the embodiment consists in depositing at least one layer of another material that is reflective, transparent, or indeed absorbent in orifices that are formed in the mirror 22.

A variant of the invention consists in structuring not the transparent layer carrying the chromophore elements, but the intermediate layer 37, by varying its thickness or even omitting it in some zones (FIG. 11B).

Thereafter, in the orifices created in this way, it is possible to deposit a transparent layer 37′ of a material other than that of the layer 37 in which the orifices have been made (FIG. 11C).

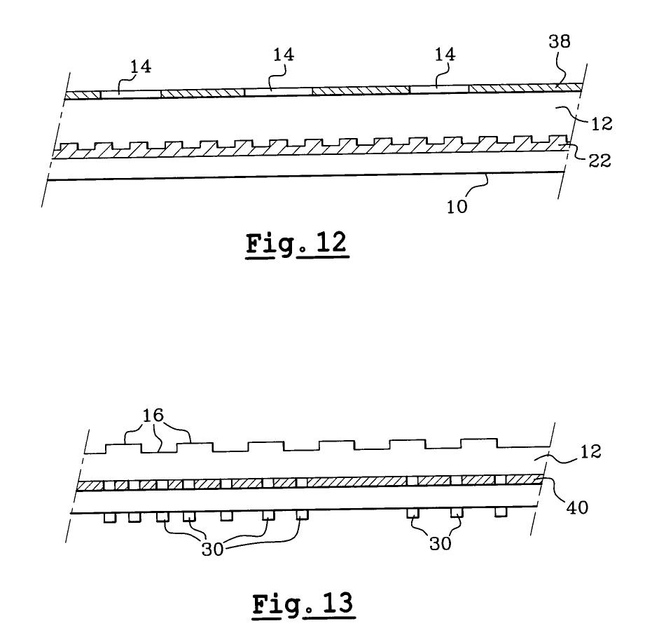

In the variant embodiments of FIGS. 12 and 13, the device has a respective opaque layer 38 or 40, e.g. a metal layer, which restricts the working areas for illumination by the excitation radiation or for transmission of fluorescence to the photodetectors, where said areas correspond to the spots 14.

In FIG. 12, the opaque layer 38 covers the layer 12 of transparent material and has orifices corresponding to the spots 14.

In a variant, the opaque layer 38 lies inside the layer 12, between its top face and the reflecting layer 22, and its orifices are in alignment with the spots 14 or with the above-mentioned zones 16.

In FIG. 13, the opaque layer 40 lies inside the substrate 10 and has orifices facing the photodetectors 30 disposed under the substrate.

1. A device for supporting chromophore elements suitable for emitting light by bioluminescence or chemiluminescence or by fluorescence in response to light excitation, the wavelength emitted by each chromophore element depending on the nature of the element, said device comprising a support adapted to receive chromophore elements on spaced-apart spots of the surface of the support, wherein the surface of the support is structured as a plurality of zones presenting optical properties differing in transmission and in reflectivity phase and amplitude, said properties resulting from the presence or absence in said zones of at least one set of layers selected from the following:
at least one layer forming a totally or partially reflecting mirror;
at least one layer that absorbs, at least in part, at least one of the emission and/or excitation wavelengths; and
at least one layer that is transparent at all of the emission and excitation wavelengths;
said layers being designed to produce at least one of the following effects:
destructive or constructive interference at at least one emission wavelength in order to generate different values of light intensity emitted by the chromophore elements;
destructive or constructive interference at at least one excitation wavelength for generating different values of the intensity of the fluorescence emitted by the chromophore elements; and
absorption of at least one excitation and/or emission wavelength to generate different values of light intensity transmitted by the substrate.

2. A device according to claim 1, wherein said zones are of dimensions in the plane of the support that are greater than the wavelengths emitted by the chromophore elements.

3. A device according to claim 1, wherein the above-mentioned zones present different characteristics (thicknesses, reflectivity phase and amplitude, absorption) making it possible, for at least one type of chromophore element, to obtain at least two different values for the intensity of the fluorescence emitted by the chromophore element of said spot, and/or for the transmitted fluorescence, and/or for the reflected excitation, and/or for the transmitted excitation.

4. A device according to claim 3, wherein the two different values comprise a minimum value and a maximum value for the intensity of the emitted fluorescence, or the transmitted fluorescence, or the reflected excitation, or the transmitted excitation.

5. A device according to claim 1, wherein said effects occur for chromophore elements of different types situated on said spot.

6. A device according to claim 5, wherein each zone corresponds to an emission intensity maximum for a determined fluorescence wavelength corresponding to a given type of chromophore element.

7. A device according to claim 1, wherein the spots are arranged in rows and/or columns of said support.

8. A device according to claim 1, wherein said zones are arranged in rows and/or columns on said support.

9. A device according to claim 1, wherein the zones form a regular structure, such as a tiling, for example.

10. A device according to claim 1, wherein the said zones are of dimensions in the plane that are greater than the dimensions of said spots.

11. A device according to claim 1, wherein said zones are of dimensions in the plane that are less than or equal to the dimensions of said spots.

12. A device according to claim 9, wherein the support is made of glass, silicon, silicon carbide, sapphire, metal, or a plastics material.

13. A device according to claim 1, including a reflective layer covered by a layer of material that is transparent to the wavelengths emitted by the chromophore elements, wherein said layer of transparent material includes at least two zones of different thicknesses, the thicknesses of said zones being determined to act by constructive or destructive optical interference to generate different values for the intensity of the fluorescence emitted by the chromophore elements on the spot.

14. A device according to claim 9, wherein said layer of transparent material has at least two types of zone of different thicknesses such that the optical path length difference in said zones is equal to an odd multiple of one-fourth of the emission wavelength of at least one type of chromophore element and/or of a corresponding excitation wavelength.

15. A device according to claim 13, including a Bragg mirror centered on an excitation wavelength, on an emission wavelength, or on a wavelength intermediate between the excitation and emission wavelengths for at least one type of chromophore element, or on a wavelength intermediate between the emission wavelengths or the excitation wavelengths of different types of chromophore element.

16. A device according to claim 13, wherein the reflective layer includes at least one optical microcavity formed by a transparent layer interposed between two reflective layers and having optical thickness equal to an odd multiple of one-fourth of the wavelength in question for which the reflectivity of the two above-mentioned reflective layers is high.

17. A device according to claim 13, including a mirror formed by at least one layer of material that is reflective at the wavelengths emitted by the chromophore elements, e.g. a reflective metal, or one or more layers of dielectric material such as, for example: a semiconductive material, an oxide, a glass, a nitride, a fluoride, a chalcogenide, an organic polymer, or an inorganic or an organometallic compound obtained by the sol-gel process.

18. A device according to claim 13, wherein the mirror is entirely opaque in the visible range of the spectrum.

19. A device according to claim 13, wherein the mirror is semitransparent in the visible range of the spectrum.

20. A device according to claim 17, wherein reflective layer is made of silicon.

21. A device according to claim 17, wherein the plane mirror comprises one or more metal layers, e.g. made of aluminum, chromium, silver, or gold.

22. A device according to claim 17, wherein the reflective layer comprises at least two oxide layers, e.g. of SiO₂, TiO₂, Nb₂O₅, Ta₂O₅, or HfO₂.

23. A device according to claim 17, wherein the plane mirror comprises at least two dielectric layers, e.g. of SiO₂ and Si₃N₄.

24. A device according to claim 17, wherein the plane mirror comprises at least two layers, one of SiO₂ and another of amorphous silicon.

25. A device according to claims 16, wherein the transparent layer includes at least one layer of dielectric material such as, for example: a semiconductive material, an oxide, a glass, a nitride, a fluoride, an organic polymer, or an inorganic or an organometallic compound obtained by the sol-gel process.

26. A device according to claim 25, wherein the transparent layer carrying the chromophore elements is made of SiO₂.

27. A device according to claim 25, wherein the transparent layer carrying the chromophore elements is made of an organic polymer.

28. A device according to claim 25, wherein the surface of said transparent layer is rough, with roughness smaller than the wavelength in question.

29. A device according to claim 1, the device being associated with means for picking up light signals emitted by the chromophore elements and with means for eliminating background noise by digitally processing light signals picked up at two different intensity levels, for a given wavelength.

30. A device according to claim 29, wherein at least one of the zones corresponds to destructive interference, canceling the light signal emitted in said zone.

31. A device according to claim 29, wherein the sensor means face the layer of transparent material.

32. A device according to claim 29, wherein the sensor means are on the side opposite from the layer of transparent material and comprise an array of photodetectors of the CCD or CMOS type secured under the device, the device having a layer of material that is reflective at the excitation wavelength and a layer of material that is absorbent at said excitation wavelength.

33. A device according to claim 32, wherein a weakly resonant cavity is formed between said reflective layer and the interface at the top surface of the layer carrying the chromophore elements.

34. A device according to claim 32, wherein said reflective layer comprises a plurality of layers deposited on a plurality of layers of material that is selectively absorbent at the excitation wavelength.

35. A device according to claim 13, wherein the top layer of the substrate is a layer having a high refractive index, such as TiO₂, for example.

36. A device according to claim 13, wherein said zones are formed by variations in the thickness of the transparent layer carrying the chromophore elements or of the above-mentioned reflective layer, or of an intermediate layer of a different refractive index between the transparent layer and the reflective layer.

37. A device according to claim 13, wherein said zones are formed by variations in the height of the above-specified mirror, the surface of the transparent layer being substantially plane.

38. A device according to claim 1, wherein said zones are formed in the transparent layer, or in an intermediate layer, or in the reflective layer, or are formed by orifices in said layers.

39. A device according to claim 38, wherein, in said orifices, there are deposited one or more layers of one or more materials different from the materials of the layers in which the orifices are formed.

40. A device according to claim 1, including at least one top layer forming a waveguide for the excitation radiation.

41. A device according to claim 32, including an opaque layer, e.g. a metal layer, having openings corresponding to the above-specified spots or to photodetectors secured under the substrate, or to the above-specified zones.

42. A device according to claim 1, the device being made in the known micro-plate format comprising a plurality of wells, the surface of the support being structured so as to present one or more of the above-specified zones per well.

43. A device according to claim 1, wherein the structured surface of the support is covered in a layer of material having a thickness of several tens of micrometers, including orifices forming micro-wells for receiving samples.

44. The method of using a device according to claim 1 in a liquid medium containing chromophore elements in succession and light-diffusing particles that generate background noise, the thickness of the liquid medium over the device being greater than the wavelengths in question, the device carrying chromophore elements fixed on the above-specified spots and emitting light signals that are sensed and separated from the background noise by digitally processing signals sensed at two different intensity levels, for one or each wavelength in question.
